(19) United States
(12) Patent Application Publication
(10) Pub. No.: US 2020/0277232 A1
(43) Pub. Date: Sep. 3, 2020

(54) FUSED RAW MATERIAL FOR THE PRODUCTION OF A REFRACTORY PRODUCT, A METHOD FOR THE PRODUCTION OF THE FUSED RAW MATERIAL AND A USE OF THE FUSED RAW MATERIAL

(71) Applicant: Refractory Intellectual Property GmbH & Co. KG, Wien (AT)

(72) Inventors: Christoph Piribauer, Hoehr-Grenzhausen (DE); Norbert Freiberger, Graz (AT); Boro Djuricic, Leoben (AT); Juergen Muehlhaeusser, Leoben (AT); Roland Nilica, St. Marein-Feistritz (AT)

(21) Appl. No.: 16/764,379

(22) PCT Filed: Oct. 30, 2018
(86) PCT No.: PCT/EP2018/079644

§ 371 Date: May 14, 2020

(30) Foreign Application Priority Data
Jan. 16, 2018 (EP) 18151894.5

(51) Int. Cl. C04B 35/443; C04B 35/657

(52) U.S. Cl. CPC C04B 35/443; C04B 35/657; C04B 2235/9607; C04B 2235/9669; C04B 2235/3895; C04B 2235/65; C04B 2235/3222

(57) ABSTRACT

The invention concerns a fused raw material for the production of a refractory product, a method for the production of the fused raw material and a use of the fused raw material.

### DESCRIPTION

The invention concerns a fused raw material for the production of a refractory product, a method for the production of the fused raw material and a use of the fused raw material.

The term “refractory product” in the sense of the invention refers in particular to refractory products with an application temperature of more than 600° C. and preferably refractory materials according to DIN 51060:2000-06, i.e. materials with a pyrometric cone equivalent >SK 17. The determination of the pyrometric cone equivalent can be carried out in particular according to DIN EN 993-12:1997-06.

Refractory products are usually produced from a batch. As is well known, a “batch” is a composition of one or more components or raw materials by which a refractory ceramic product can be produced by means of a temperature treatment.

The raw materials from which such a refractory batch can be produced to produce a refractory product are usually based on at least one of the oxides MgO, CaO, Al₂O₃, SiO₂ or ZrO₂. A raw material based on at least one of the oxides MgO or CaO is designated as basic and a raw material based on at least one of the oxides Al₂O₃, SiO₂ or ZrO₂ is designated as non-basic or acidic.

In addition to the aforementioned oxides, raw materials may also contain non-oxide substances, for example carbides in the form of SiC, Al₄C₃ or Al₂OC.

Depending on the application conditions of the refractory product produced from the batch, the raw materials for the batch used to produce the product must be selected. For example, basic raw materials must be selected for refractory products exposed to basic attack, such as basic slags. Similarly, for refractories exposed to acid attack, non-basic raw materials must be selected.

In order to improve the slag resistance of a refractory product, it is also advantageous if the batch used to produce the product includes non-oxide raw materials, as these have a favorable wetting behavior towards slags. However, many of these non-oxide raw materials, in particular Al₄C₃ and Al₂OC, have a tendency to hydrate and therefore have limited resistance under ambient conditions.

Furthermore, the thermal expansion of the raw material must be taken into account when using the refractory product. For example, corundum (Al₂O₃) has a thermal expansion of 8 ppm/K and magnesia (MgO) has a thermal expansion of 13 ppm/K. ZrO₂ has a thermal expansion of about 7 ppm/K and also undergoes volume jumps during its temperature-dependent modification changes, which are usually referred to as martensitic transformation.

However, it is well known that the lowest possible thermal expansion of a refractory raw material is advantageous for the thermal shock behavior of the refractory product produced using this raw material.

It is an object of the present invention to provide a raw material for the production of a refractory product.

In particular, it is an object of the present invention to provide a raw material for the production of a refractory product which has a good resistance to both basic and non-basic attack, in particular a good resistance to basic and non-basic slags.

Furthermore, it is an object of the present invention to provide a raw material for the production of a refractory product which has a favorable wetting behavior against slags and does not tend to hydrate.

Furthermore, it is an object of the present invention to provide a raw material for the production of a refractory product which has a low thermal expansion.

In order to solve these objects, according to the invention, a fused raw material is provided for the production of a refractory product, which comprises the following mineralogical phases:

magnesia spinel with a hyperstoichiometric proportion of Al₂0₃; and Al₄O₄C.

The raw material according to the invention is a completely new fused raw material, i.e. a raw material obtained from a cooled melt. The fused raw material according to the invention has a mineralogical composition which, on the one hand, comprises the mineralogical phase magnesia spinel with a hyperstoichiometric proportion of Al₂O₃ (hereinafter also referred to as “hyperstoichiometric magnesia spinel”) and, on the other hand, the mineralogical phase Al₄O₄C. In addition to these mineralogical phases in the form of hyperstoichiometric magnesia spinel and Al₄O₄C, the fused raw material according to the invention may have one or more further mineralogical phases.

Surprisingly, it turned out according to the invention that the novel fused raw material according to the invention is excellently usable as raw material for the production of a refractory product. According to the invention, it has been found that the fused raw material has an excellent resistance to both basic and non-basic attack, in particular an excellent resistance to basic and non-basic slags. The inventors assume that this good resistance is based on the specific combination of the hyperstoichiometric magnesia spinel comprising both MgO and Al₂O₃ and the non-oxidic aluminium oxycarbide phase in the form of Al₄O₄C.

Furthermore, the fused raw material according to the invention exhibits an extremely favorable wetting behavior towards slags. This favorable wetting behavior, which is comparable to the wetting behavior of carbon in Al₄O₄C carbon bricks and MgO carbon bricks, is probably due to the presence of the non-oxide phase in the form of Al₄O₄C.

Furthermore, according to the invention, it turned out surprisingly that the fused raw material according to the invention has only an extremely low thermal expansion, so that a refractory product with a good thermal shock behavior can be produced from the fused raw material according to the invention.

The hyperstoichiometric magnesia spinel, which the fused raw material according to the invention has as a mineralogical phase, is a magnesia spinel with a hyperstoichiometric incorporation of Al₂O₃. Magnesia spinel is known to be a mineralogical phase consisting of the oxides MgO and Al₂O₃, which is present in the form of MgO.Al₂O₃ or MgAl₂O₄, respectively, at stoichiometric proportions of MgO and Al₂O₃. At such stoichiometric fractions of Al₂O₃ and MgO in the magnesia spinel, the latter has a theoretical composition of 71.67% by mass Al₂O₃ and 28.33% by mass MgO. A magnesia spinel with a hyperstoichiometric proportion of Al₂O₃ is accordingly present if the proportion of Al₂O₃ is above 71.67% by mass.

In the fused raw material according to the invention, a hyperstoichiometric magnesia spinel is preferably present in which Al₂O₃ is present in a mass fraction of more than 71.67% by mass. According to a preferred embodiment, Al₂O₃ is present in the hyperstoichiometric magnesia spinel in a mass fraction ranging of 72 to 97% by mass. Correspondingly, the mass fraction of MgO in the hyperstoichiometric magnesia spinel is in the range of 3 to 28% by mass in this embodiment. The figures given in % by mass are based on the total mass of the hyperstoichiometric magnesia spinel.

In accordance with the invention, it turned out surprisingly that the advantageous properties of the fused raw material according to the invention, in particular its excellent resistance to slags, are increasingly improved and in particular its thermal expansion is also increasingly reduced, as far as the proportion of Al₂O₃ in the hyperstoichiometric magnesia spinel increasingly approaches a proportion of 93.2% by mass. Correspondingly, the proportion of MgO in the hyperstoichiometric magnesia spinel is 6.8% by mass in this embodiment. The figures given in % by mass are based on the total mass of the hyperstoichiometric magnesia spinel.

According to a particularly preferred embodiment, the hyperstoichiometric magnesia spinel of the fused raw material according to the invention has a proportion of Al₂O₃ in the range of 77 to 97% by mass and a proportion of MgO in the range of 3 to 23% by mass. According to an even more preferred embodiment, the hyperstoichiometric magnesia spinel has a proportion of Al₂O₃ in the range of 85 to 95% by mass and a proportion of MgO in the range of 5 to 15% by mass. The figures given in % by mass are based on the total mass of the hyperstoichiometric magnesia spinel

Expressed in mol and normalized to O₄, the properties of the fused raw material according to the invention are then increasingly improved when the hyperstoichiometric magnesia spinel is increasingly approaching a composition of Mg_{0.23}Al_{2.5}O₄. In this respect, according to one embodiment, the hyperstoichiometric magnesia spinel can be present in the form of Mg_{0.0338-0.9878}Al_{2.008-2.644}O₄. According to a preferred embodiment, the magnesia spinel can thus be in the form of Mg_{0.1-0.8}Al_{2.13-2.60}O₄ and even more preferably in the form of Mg_{0.16-0.52}Al_{2.3-2.6}O₄.

The aluminium oxycarbide Al₄O₄C is a non-oxide, which is already known in this form as a state of the art substance. However, the use of Al₄O₄C in a fused raw material comprising magnesia spinel was unknown until now. Completely surprising were the advantageous properties of a fused raw material in which Al₄O₄C is present in addition to magnesia spinel with a hyperstoichiometric proportion of Al₂O₃.

According to a preferred embodiment, the fused raw material according to the invention comprises the hyperstoichiometric magnesia spinel and Al₄O₄C in the following mass fractions:

Magnesia spinel: 50 to 99% by mass;

Al₄O₄C: 1 to 50% by mass.

The figures given in % by mass are each based on the total mass of the fused raw material.

In accordance with the invention, it has been found that the advantageous properties of the raw melt material according to the invention are increasingly improved if the proportion of hyperstoichiometric magnesia spinel in the raw melt material is increasingly close to a proportion of 80% by mass and the proportion of Al₄O₄C in the raw melt material is increasingly close to a proportion of 20% by mass, in each case based on the total mass of the fused raw material.

According to a particularly preferred embodiment, it is therefore provided that the fused raw material comprises the hyperstoichiometric magnesia spinel and Al₄O₄C in the following mass fractions:

Magnesia spinel: 60 to 95% by mass;

Al₄O₄C: 5 to 40% by mass.

The figures given in % by mass are each based on the total mass of the fused raw material.

According to an even more preferred embodiment, it is provided that the fused raw material will comprises hyperstoichiometric magnesia spinel and Al₄O₄C in the following mass fractions:

Magnesia spinel: 70 to 90% by mass:

Al₄O₄C: 10 to 30% by mass.

The figures given in % by mass are each based on the total mass of the fused raw material.

In accordance with the invention, it has been found that the fused raw material according to the invention has a particularly low thermal expansion as far as the mass ratio of hyperstoichiometric magnesia spinel to Al₄O₄C increasingly approaches a value of 4. In this respect, according to the invention, it may be preferably provided that the mass ratio of hyperstoichiometric magnesia spinel to Al₄O₄C in the fused raw material according to the invention is in the range from 1.5 to 19, even more preferably in the range from 2 to 9 and even more preferably in the range from 2.3 to 5.7.

In accordance with the invention, it has been found that the aforementioned advantageous properties of the fused raw material according to the invention can be worsened to the extent that it contains further phases or substances in addition to the mineralogical phases of hyperstoichiometric magnesia spinel and Al₄O₄C. According to a preferred embodiment, it is therefore provided that the fused raw material comprises hyperstoichiometric magnesia spinel and Al₄O₄C in a total mass of at least 95% by mass. It is even more preferably provided that the fused raw material comprises hyperstoichiometric magnesia spinel and Al₄O₄C in a total mass of at least 97% by mass and even more preferably in a total mass of at least 99% by mass, in each case based on the total mass of the fused raw material.

Accordingly, the fused raw melt material according to the invention has, in addition to hyperstoichiometric magnesia spinel and Al₄O₄C, further phases or substances preferably in a proportion of less than 5% by mass, even more preferably less than 3% by mass and even more preferably less than 1% by mass, in each case based on the total mass of the fused raw material.

Such further phases can be present, for example, in the form of the hydration-prone phases Al₄C₃ or Al₂OC. Preferably, the fused raw material comprises Al₄C₃ in a proportion of less than 2% by mass, even more preferably in a proportion of less than 1% by mass. Furthermore, the fused raw material comprises Al₂OC preferably in a proportion of less than 2% by mass, even more preferably in a proportion of less than 1% by mass. The figures given are based on the total mass of the fused raw material.

Furthermore, it has been found that the properties of the fused raw material can be improved if it comprises the oxides CaO, SiO₂ and Fe₂O₃ in a total mass of less than 5% by mass. According to a preferred embodiment, it is therefore provided that the fused raw material has a total mass of CaO, SiO₂ and Fe₂O₃ of less than 5% by mass, even more preferably less than 3% by mass. Preferably, the fused raw material should comprise CaO in a proportion of less than 2% by mass, even more preferably in a proportion of less than 1% by mass. Furthermore, the fused raw material preferably comprises SiO₂ with less than 2% by mass, even more preferably less than 1% by mass. Furthermore, the fused raw material preferably comprises Fe₂O₃ with less than 2% by mass, even more preferably less than 1% by mass. The figures presented are each related to the total mass of the batch.

Furthermore, it is preferably provided that the fused raw material should comprise the following oxides or substances in the mass proportions specified below, in each case based on the total mass of the fused raw material, whereby one, but preferably as many as possible, i.e. several or all of the substances specified below may be present in the mass proportions specified:

ZrO₂: less than 1% by mass;

TiO₂: less than 1% by mass;

total mass of Na₂O, K₂O and Li₂O: less than 1% by mass;

SiC: less than 1% by mass.

The fused raw material according to the invention has a very low thermal expansion. In particular, the fused raw material exhibits a thermal expansion of at most 8.0 ppm/K, more preferably below 7.0 ppm/K and even more preferably below 6.5 ppm/K. The fused raw material according to the invention has a thermal expansion in the range of 5.6 to 6.4 ppm/K. The thermal expansion is determined in each case at 1,000° C. according to DIN 51045-4:2007-01.

The fused raw material according to the invention preferably has a microstructure which has a matrix in the form of the hyperstoichiometric magnesia spinel, in which the phase in the form of Al₄O₄C is embedded. In particular, Al₄O₄C is embedded in the magnesia spinel matrix in the form of isolated islands. In the event of a corrosive or mechanical attack on the fused raw material, the Al₄O₄C can oxidize on the surfaces of the fused raw material newly created by the attack, which is accompanied by an increase in volume that can lead to the closing of cracks in the fused raw material. Due to this self-healing effect, the fused raw material has a good resistance to external attacks.

One subject of the invention is also a method for the production of the fused raw material according to the invention. The method for the production of the fused raw material according to the invention comprises the following steps:
Providing a batch having a chemical composition which comprises

Al₂O₃;

MgO; and

C;
forming a melt from the batch; and
cooling of the melt; wherein
Al₂O₃, MgO and C are present in such proportions that when the melt is formed and cooled, a portion of the Al₂O₃ with MgO forms magnesia spinel with a hyperstoichiometric proportion of Al₂O₃ and a portion of the Al₂O₃ with C forms Al₄O₄C.

For the production of the fused raw material according to the invention, a batch is thus provided which has a chemical composition comprising the oxides Al₂O₃ and MgO as well as carbon (C). For the production of a fused raw material in accordance with the invention from such a batch, it is first subjected to temperature in such a way that a melt is formed from the batch, i.e. the batch is melted. Afterwards the formed melt is cooled. In order to produce a fused raw material in accordance with the invention from the batch during this treatment of the batch, Al₂O₃, MgO and C are present in the batch in such proportions that during the formation of the melt and its subsequent cooling, a proportion of the Al₂O₃ forms with the MgO magnesia spinel with a hyperstoichiometric proportion of Al₂O₃ and a further proportion of the Al₂O₃ forms Al₄O₄C with the carbon of the batch.

The batch provided for carrying out the process according to the invention may consist of one or more components or raw materials comprising Al₂O₃, MgO and C.

A component comprising MgO may be in the form of one or more of the following raw materials: caustic magnesia, sintered magnesia or fused magnesia.

A component comprising Al₂O₃ may be in the form of one or more of the following raw materials: calcined alumina, sintered alumina or fused alumina.

A component comprising MgO and Al₂O₃ may be in the form of magnesia spinel, preferably in the form of magnesia spinel with a hyperstoichiometric proportion of Al₂O₃.

A component comprising carbon may be in the form of one or more of the following raw materials: graphite, carbon black or petroleum coke.

According to one embodiment, the batch consists of at least one component comprising magnesia, at least one component comprising Al₂O₃ and one component comprising carbon.

According to an alternative embodiment, the batch consists of a component comprising MgO and Al₂O₃ in the form of magnesia spinel with a hyperstoichiometric proportion of Al₂O₃ and a component comprising carbon and optionally at least one further component comprising Al₂O₃.

In order to produce a fused raw material in accordance with the invention from such an batch comprising Al₂O₃, MgO and C when carrying out the process in accordance with the invention, Al₂O₃ is present in such proportions that, during the formation and subsequent cooling of the melt, a proportion of the Al₂O₃ forms hyperstoichiometric magnesia spinel with the MgO and a further proportion of the Al₂O₃ forms Al₄O₄C with the C of the batch.

During the formation and subsequent cooling of the melt, a portion of the Al₂O₃ and the carbon of the batch react according to the following equation (I):

2 Al₂O₃+3 C Al₄O₄C+2 CO (I)

It is also known that Al₂O₃ and MgO react with each other according to the following equation (II) to form a stoichiometric magnesia spinel:

Al₂O₃+MgO MgAl₂O₄ (II)

According to stoichiometry, one mole of Al₂O₃ and one mole of MgO react to form a stoichiometric magnesia spinel. To form a magnesia spinel with a hyperstoichiometric proportion of Al₂O₃, the molar ratio of Al₂O₃ to MgO must therefore be greater than 1.

On this basis, it is possible to provide for the proportions of Al₂O₃, MgO and C in the batch provided for the process in such proportions that, when carrying out the method according to the invention, a fused raw material according to the invention is formed which comprises magnesia spinel with a hyperstoichiometric proportion of Al₂O₃ and Al₄O₄C.

According to the invention, it has been found that MgO can escape from the melt in small proportions in gaseous form when the process according to the invention is carried out. Furthermore, according to the invention, it has been found that C can form CO in the melt in higher proportions than according to the stoichiometry according to equation (I). In this respect, it can be provided according to the invention that in a batch provided for carrying out the method according to the invention, MgO and C are present in higher proportions than would be necessary for the formation of a fused raw material according to equations (I) and (II).

According to an embodiment, the batch provided for the method according to the invention may have a chemical composition comprising Al₂O₃, MgO and C in the following mass fractions:

Al₂O₃: 77.5 to 98.5% by mass;

MgO: 1 to 22% by mass;

C: 0.5 to 15% by mass.

The figures given in % by mass are each related to the total mass of the batch.

As explained above, it was determined in accordance with the invention that the advantageous properties of the fused raw material according to the invention are increasingly improved to the extent that the proportion of hyperstoichiometric magnesia spinel increasingly approaches a mass proportion of 80% and the proportion of Al₄O₄C increasingly approaches a mass proportion of 20% by mass. A fused raw material according to the invention with a mass fraction of 80% of hyperstoichiometric magnesia spinel and with a mass fraction of 20% Al₄O₄C can be produced by the method according to the invention, in particular if the batch provided for the method according to the invention has a chemical composition which comprises

Al₂O₃, MgO and C in the following mass fractions:

Al₂O₃: 82% by mass;

MgO: 8% by mass;

C: 10% by mass. The figures given in % by mass are in each case based on the total mass of the batch.

In order to approximate the mass fractions of Al₂O₃, MgO and C in the batch to these particularly advantageous fractions of 82% by mass, 8% by mass and 10% by mass, it may be provided according to a preferred embodiment that the batch provided for the method according to the invention has a chemical composition which comprises Al₂O₃, MgO and C in the following mass fractions:

Al₂₀₃: 78 to 90% by mass;

MgO: 4 to 17% by mass;

C: 5 to 13% by mass.

The figures given in % by mass are each related to the total mass of the batch.

Even more preferably, it may be provided that the batch provided for the method according to the invention has a chemical composition which comprises Al₂O₃, MgO and C in the following mass fractions

Al₂O₃: 78 to 85% by mass;

MgO: 6 to 15% by mass;

C: 8 to 12% by mass.

The figures given in % by mass are each related to the total mass of the batch.

According to a preferred embodiment, it is therefore provided that the batch has a chemical composition which comprises Al₂O₃, MgO and C in a total mass of at least 95% by mass, even more preferably in a total mass of at least 97% by mass and even more preferably in a total mass of at least 99% by mass, in each case relative to the total mass of the batch.

Furthermore, it may preferably be provided that the batch has a chemical composition comprising the oxides CaO, SiO₂ and Fe₂O₃ in a total mass of less than 5% by mass, even more preferably less than 3% by mass. Preferably, the batch has a chemical composition which contains CaO in a proportion of less than 2% by mass, even more preferably in a proportion of less than 1% by mass. Furthermore, the batch preferably has a chemical composition that contains SiO₂ in a proportion of less than 2% by mass, even more preferably in a proportion of less than 1% by mass. Furthermore, the batch preferably has a chemical composition that contains Fe₂O₃ in a proportion of less than 2% by mass, even more preferably in a proportion of less than 1% by mass. The figures given are each related to the total mass of the batch.

Furthermore, it is preferably provided that the batch has a chemical composition which contains the following oxides in the mass fractions specified below, in each case based on the total mass of the batch, whereby one, but preferably as many as possible, i.e. several or all of the substances specified below may be present in the mass fractions specified:

ZrO₂: less than 1% by mass;

TiO₂: less than 1% by mass;

total mass of Na₂O, K₂O and Li₂O: less than 1% by mass.

In order to form a melt from the batch, it can be subjected to temperature by the technologies known from the state of the art in such a way that the batch melts and forms a melt. In particular, the melt in an electric arc furnace can be subjected to temperatures such that a melt is formed from the batch. Preferably, the batch can be melted, especially in an electric arc furnace, at a temperature in the range of 2,100° C.

The melt is then cooled down, especially to room temperature. During cooling, a portion of the Al₂O₃ forms with the MgO hyperstoichiometric magnesia spinel. Furthermore, a further portion of the Al₂O₃ forms Al₄O₄C with C during the cooling of the melt.

The resulting fused raw material, which is in accordance with the invention, can preferably be made provided as raw material for the production of a refractory product.

One subject of the invention is also the use of the fused raw material according to the invention for the production of a refractory product with the following proviso:
Provision of a fused raw material according to the invention;
mixing the fused raw material with at least one additional raw material to produce a refractory batch;
application of temperature to the batch.

Preferably, the fused raw material according to the invention is provided as bulk material, i.e. as granular material or quantity of grains.

The fused raw material can be mixed with one or more additional raw materials to produce a refractory batch. These additional raw materials can basically be any one or more raw materials known from the state of the art for the production of a refractory product. Preferably, the fused raw material according to the invention is mixed with one or more additional raw materials based on at least one of the oxides MgO or Al₂O₃, for example with one or more of the following additional raw materials: magnesia, alumina or magnesia spinel. Magnesia may, for example, be in the form of one or more of the following raw materials: sintered magnesia or fused magnesia. Alumina may be in the form of one or more of the following raw materials: calcined alumina, fused alumina or sintered alumina. Magnesia spinel, for example, may be in the form of one or more of the raw materials sinter spinel or fused spinel.

The batch can preferably be used to produce a sintered, i.e. ceramic refractory product. For this purpose, the batch can be mixed, for example, with a binder, especially an organic binder. Lignin sulfonate, for example, can be used as an organic binder.

Alternatively, the batch can be used to produce a carbon brick, i.e. a refractory product with a carbon bond. In this respect, the fused raw material according to the invention can be mixed with one or more of the aforementioned raw materials based on at least one of the oxides MgO or Al₂O₃ and, in addition, with a conventional carbon carrier—in particular graphite, soot or pitch.

The batch can then be shaped, for example by pressing, and then dried, for example.

Finally, the batch, which may have been formed and dried, is subjected to temperature. In particular, to produce a sintered product, the batch is subjected to a ceramic firing, i.e. a sinter firing in which the components of the batch sinter to a refractory ceramic product. A refractory ceramic product is then present in the form of a sintered body.

According to the invention, it has been found that by using the fused raw material according to the invention to produce a refractory product, such a product with only low thermal expansion and excellent resistance to basic and non-basic attacks can be produced. In this respect, it has been found, for example, that a refractory product in the form of a brick for lining a rotary cement kiln can be produced using the fused raw material according to the invention, in particular in the form of a sintered body as described above. One subject of the invention is also such a brick for lining a rotary cement kiln, produced using the fused raw material according to the invention.

Further features of the invention result from the claims and the following exemplary embodiment.

All features of the invention can be combined with each other, individually or in combination.

An exemplary embodiment of the invention is explained in more detail in the following.

### EXEMPLRY EMBODIMENT

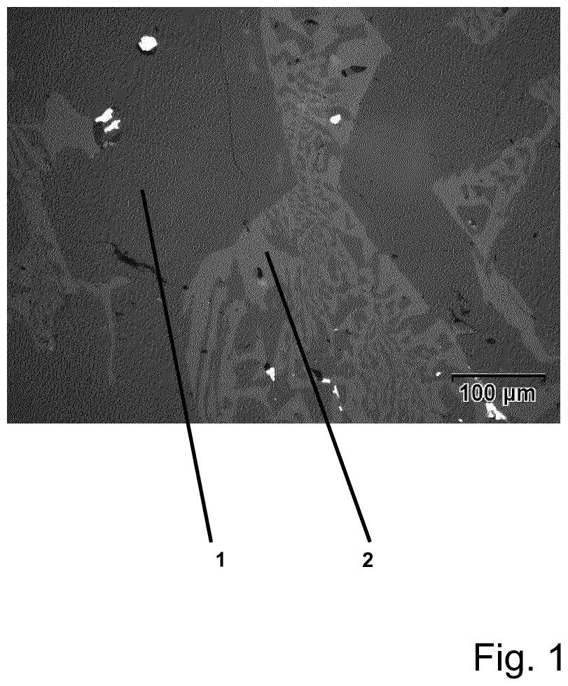

In the following description of the exemplary embodiment FIG. 1 shows a scanning electron microscope image of a section of the fused raw material produced according to the exemplary embodiment

First, a synthetic raw material based on the oxides MgO and Al₂O₃ was produced. For this purpose, the starting raw materials 9% by mass caustic magnesia (with a purity of more than 99% by mass MgO) and 91% by mass calcined alumina (with a purity of more than 99% by mass Al₂O₃) were mixed together. The mixture was granulated and then subjected to a temperature of 1,700° C. for five hours. During this temperature exposure, a synthetic raw material with the following chemical composition was formed from the starting raw materials: 8.77% by mass MgO; 90.56% by mass Al₂O₃; 0.67% by mass other oxides (especially SiO₂, CaO, Fe₂O₃ and Na₂O).

This synthetic raw material was processed into a grain mixture with a grain size in the range of >0 to 1 mm.

To carry out the method in accordance with the invention, a batch was provided which contained 90% by mass of this synthetic raw material and 10% by mass of petroleum coke (with a purity of over 99% by mass carbon).

Afterwards, the batch had the following chemical composition:

Al₂O₃: 81.5% by mass;

MgO: 7.9% by mass;

C: 9.9% by mass;

Remainder: 0.7% by mass.

This batch was then melted in an electric arc furnace at a temperature of 2,100° C. The formed melt was then cooled down to room temperature. The melt cooled down to room temperature represented an exemplary embodiment of a fused raw material according to the invention.

The resulting raw material had a mineralogical composition of 79.8% by mass of magnesia spinel with a hyperstoichiometric proportion of Al₂O₃ and 19.6% by mass of Al₄O₄C, in addition to a remainder (especially SiO₂, CaO, Fe₂O₃ and Na₂O) with a proportion of 0.6% by mass.

The magnesia spinel with a hyperstoichiometric proportion of Al₂O₃ had, based on the mass of the magnesia spinel, a proportion of MgO of 6.76% by mass and a proportion of Al₂O₃ of 93.24% by mass. Expressed in moles and normalized to 4 moles of oxygen, this results in a mineralogical phase Mg_{0.23}Al_{2.51}O₄.

The thermal expansion of the fused raw material was determined according to DIN 51045-4:2007-01 at 1,000° C. at 5.92 ppm/K (average value from three measurements).

A scanning electron microscope image of a section of the fused raw material produced according to this example was taken. This image is shown in FIG. 1. The black bar at the bottom right of the image corresponds to a length of 100 μm.

The matrix of hyperstoichiometric spinel, which appears as a darker area and is marked with the reference symbol 1, is clearly visible. In this matrix 1 the phase Al₄O₄C, which is marked with the reference sign 2, is embedded, which appears as a brighter area.

1. Fused raw material for the production of a refractory product comprising the following mineralogical phases:
Magnesia spinel with a hyperstoichiometric proportion of Al₂O₃; and
Al₄O₄C.

2. Fused raw material according to claim 1, comprising the following mineralogical phases in the following proportions:
Magnesia spinel with a hyperstoichiometric proportion of Al₂O₃:50 to 99% by mass; and
Al₄O₄C: 1 to 50% by mass.

3. Fused raw material according to claim 1, comprising the following mineralogical phases in the following proportions:
Magnesia spinel with a hyperstoichiometric proportion of Al₂O₃:70 to 90% by mass; and
Al₄O₄C: 10 to 30% by mass.

4. Fused raw material according to claim 1, wherein the magnesia spinel with a hyperstoichiometric proportion of Al₂O₃ has a proportion of Al₂O₃ in the range from 77 to 97% by mass.

5. Fused raw material according to claim 1, comprising magnesia spinel with a hyperstoichiometric proportion of Al₂O₃ and Al₄O₄C in a total mass of at least 95% by mass.

6. Fused raw material according to claim 1, comprising magnesia spinel with a hyperstoichiometric proportion of Al₂O₃ and Al₄O₄C in a total mass of at least 99% by mass.

7. Fused raw material according to claim 1, having a thermal expansion of at most 8.0 ppm/K.

8. Method for producing a fused raw material according to claim 1, comprising the following steps:
providing a batch having a chemical composition which comprises:
Al₂O₃;
MgO; and
C;
forming a melt from the batch; and
cooling the melt;
wherein Al₂O₃, MgO and C are present in such proportions that, when the melt is formed and cooled, a portion of the Al₂O₃ with MgO forms magnesia spinel with a hyperstoichiometric proportion of Al₂O₃ and a portion of the Al₂O₃ with C forms Al₄O₄C.

9. The method according to claim 8, wherein the batch has a chemical composition comprising the following substances in the following proportions:
Al₂O₃: 77.5 to 98.5% by mass;
MgO: 1 to 22% by mass; and
C: 0.5 to 15% by mass.

10. The method according to claim 8, wherein the batch has a chemical composition comprising the following substances in the following proportions:
Al₂O₃: 78 to 85% by mass;
MgO: 6 to 15% by mass;
C: 8 to 12% by mass.

11. Use of the fused raw material according to claim 1 for the production of a refractory product with the following proportions:
provision of a fused raw material according to claim 1; mixing the fused raw material with at least one additional raw material to produce a refractory batch; and
application of temperature to the batch.
